(19) United States
(12) Patent Application Publication
(10) Pub. No.: US 2023/0290037 A1
(43) Pub. Date: Sep. 14, 2023

(54) REAL-TIME PROGRESSIVE TEXTURE MAPPING OF A 3D MESH

(71) Applicant: STREEM, LLC, Portland, OR (US)

(72) Inventors: Flora Ponjou Tasse, London (GB); Pavan Kumar Kamaraju, London (GB); Ghislain Fouodji Tasse, London (GB)

(73) Assignee: STREEM, LLC, Portland, OR (US)

(21) Appl. No.: 17/890,965

(22) Filed: Aug. 18, 2022

Related U.S. Application Data
(60) Provisional application No. 63/318,694, filed on Mar. 10, 2022.

(51) Int. Cl. G06T 15/04; G06T 17/20; G06T 7/55; G06T 7/80

(52) U.S. Cl. CPC G06T 15/04; G06T 17/20; G06T 7/55; G06T 7/80

(57) ABSTRACT

Embodiments include systems and methods for real-time progressive texture mapping of a 3d mesh. A sequence of frames of a scene captured by a capturing device, and keyframes that partially overlap in the sequence of frames are added to a queue of keyframes. A 3D mesh created from the sequence of frames is accessed. A computing device determines when changes to a property of the 3D mesh meet a predetermined threshold. One of the keyframes from the queue of keyframes is assigned to each face in the 3D mesh, and the 3D mesh is divided into mesh segments based on the assigned keyframes. The keyframe assigned to each of the mesh segments is used to compute texture coordinates for vertices in the respective mesh segment, and an image in the keyframe is assigned as a texture for the respective mesh segment.

### CROSS-REFERENCE TO RELATED APPLICATIONS

This application claims the benefit of U.S. Provisional Application No. 63/318,694, filed on Mar. 10, 2022, the entire contents of which are hereby incorporated by this reference as if fully stated herein.

### TECHNICAL FIELD

The present disclosure relates to the field of remote augmented reality (AR), and specifically to real-time progressive texture mapping of a 3D mesh created from a video feed.

### BACKGROUND

Devices such as smartphones and tablets are increasingly capable of supporting augmented reality (AR). These devices may capture images and/or video and, depending upon the particulars of a given AR implementation, the captured images or video may be processed using various algorithms to detect features in the video, such as planes, surfaces, faces, and other recognizable shapes. Further, the captured images or video can be combined in some implementations with data from depth sensors such as LiDAR, and camera pose information obtained from motion data captured from sensors such as a MEMS gyroscope and accelerometers, which can facilitate AR software in recreating an interactive 3-D model. This 3-D model can further be used to generate and place virtual objects within a 3-D space represented by the captured images and/or video. These point clouds or surfaces may be associated and stored with their source images, video, and/or depth or motion data. In various implementations, the devices can be capable of supporting a remote video session with which users can interact via AR objects in real-time.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates an example system that may allow capture of a video feed and camera pose information, and transmission of the same to a remote device, for interaction and placement of AR objects.

FIG. 2 depicts an example method for generation of a 3D model and placement, where the AR object is reflected into a video stream from an end user device, such as device.

FIG. 3A illustrates an example process for real-time texture mapping of a 3D model according to some embodiments.

FIG. 3B illustrates an example 3D mesh created from the frames of the video stream over time.

FIG. 4 illustrates further details of the process for real-time texture mapping of a 3D model according to some embodiments.

FIG. 5 is a block diagram of an example computer that can be used to implement some or all of the components of the system of FIG. 1, according to various embodiments.

FIG. 6 is a block diagram of a computer-readable storage medium that can be used to implement some of the components of the system or methods disclosed herein, according to various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

A device that supports augmented reality (AR) typically provides an AR session on a device-local basis (e.g., not requiring communication with a remote system), such as allowing a user of the device to capture a video feed or stream using a camera built into the device, and superimpose AR objects upon the video as it is captured. Support for superimposing AR objects is typically provided by the device's operating system, with the operating system providing an AR application programming interface (API). Examples of such APIs include, but are not limited to, Apple's ARKit, provided by iOS, and Google's ARCore, provided by Android.

These APIs may provide depth data and/or a point cloud, which typically includes one or more points that are indicated by an x, y position within the video frame along with a depth (or z-axis). These x, y, and z values can be tied to one or more identified anchor features within the frame, e.g. a corner or edge of an object in-frame, which can be readily identified and tracked for movement between frames. Use of anchor features can allow the detected/calculated x, y, and z values to be adjusted from frame to frame relative to the anchor features as the camera of the capturing device moves in space relative to the anchor features. These calculated values allows AR objects to be placed within a scene and appear to be part of the scene, viz. the AR object moves through the camera's view similar to other physical objects within the scene as the camera moves. Further, by employing various techniques such object detection along with motion data (which may be provided by sensors on-board the device such as accelerometers, gyroscopes, compasses, etc.), the API can maintain track of points that move out of the camera's field of view. This allows a placed AR object to disappear off-screen as the camera moves past its placed location, and reappear when the camera moves back to the scene location where the AR object was originally placed.

The device may also be used to engage in a video communications session with a remote user, such as another device or system that is likewise capable of video communications. By transmitting or otherwise sharing the depth data and/or point cloud, the remote user can be enabled to insert AR objects into the video feed, which can then be reflected back to the device providing the video feed and subsequently tracked by the device as if placed by the device user.

However, where the video feed and associated depth and motion data are simply used to recreate the view on the capturing device for the remote user, the remote user is constrained in placing AR objects only to where the device user is currently pointing the device. The remote user cannot place or otherwise associate an AR object with any objects that are not currently in-frame. A solution to such a problem is to use the video feed and associated depth and motion data to progressively create a 3D model of the environment captured in the video feed. Thus, as the user of the capturing device pans the device about, the remote user is provided with a progressively expanding 3D model or mesh, which can be refined when the user of the capturing device pans back over areas that were previously captured. As used herein, the terms 3D mesh and 3D model may be used interchangeably and refer to a collection of vertices, edges, and faces that describe the shape of a 3D object or scene.

During a live AR session, a 3D mesh of the scene is often reconstructed, either by the underlying platform (ARKit on Lidar-enabled devices) or a custom algorithm. In both cases, a mesh of the scene is continuously updated as more of the physical environment is captured by the AR device. This 3D mesh is typically not textured, and does not fully capture the details of the scene.

Current methods for scanning 3D environments typically output a 3D mesh that either has no color information, or has color data per vertex. These meshes do not have texture information, and thus high-resolution details of the scene are not captured during the reconstruction. Conventional texture mapping of the 3D mesh is typically done in a post-processing step (such as MVS Texturing), on a server, after the scanning by the AR device is complete. This is because texture mapping is often a very expensive operation: it requires determining for each vertex on the mesh the correct video frame to select as texture and use to compute texture coordinates. Moreover in a live scanning scenario, the mesh is constantly updated as more of the scene is captured by the camera. This means that this texture mapping operation has to be repeated every time the mesh is changed. Other conventional methods, such as TextureFusion, propose real-time texture mapping of a 3D mesh, but requires significant amount of computer resources which make the methods unsuitable for deployment on mobile devices.

Disclosed embodiments include systems and methods that allow for real-time texture mapping on a live 3D mesh and that can run locally on the AR device, such as a mobile device, rather than requiring a remote server.

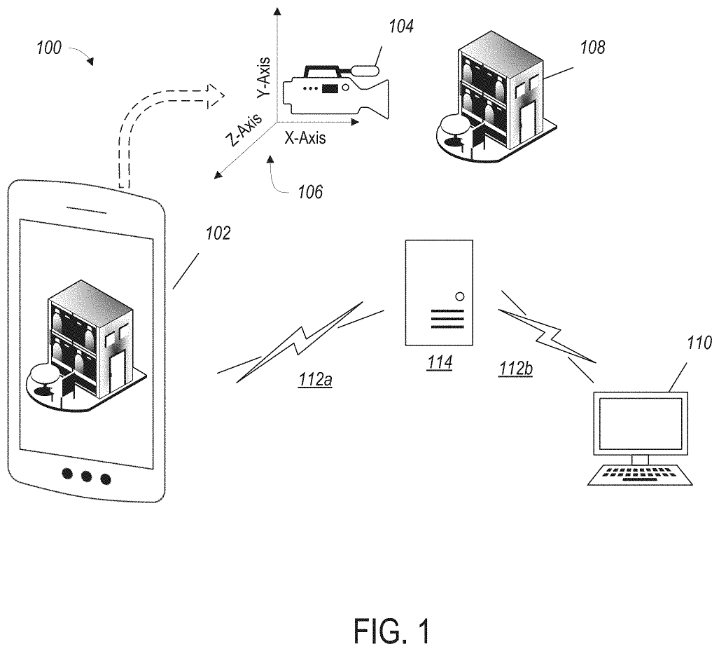

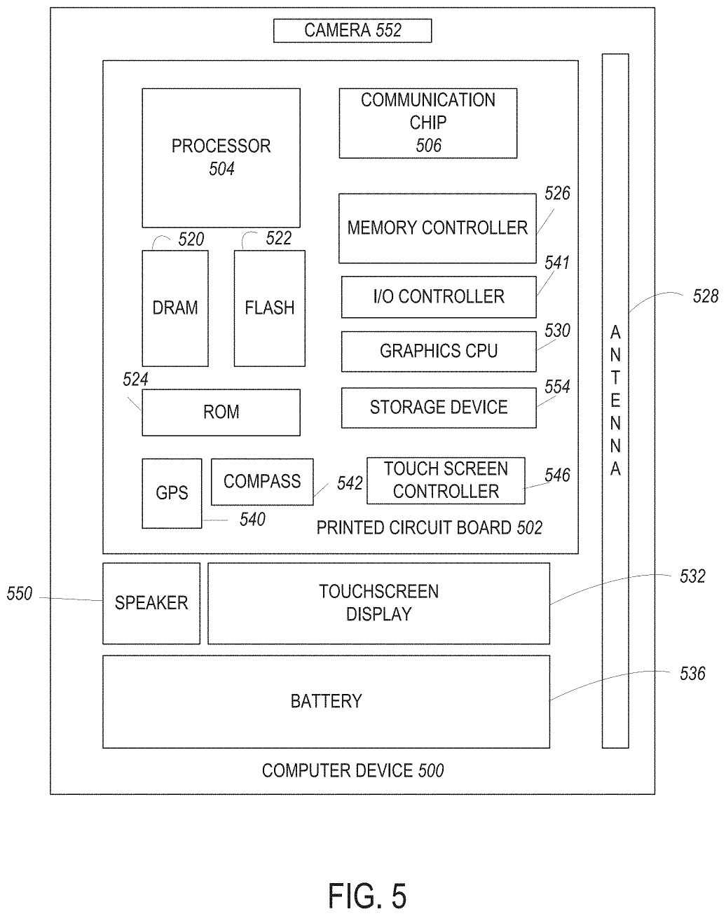

FIG. 1 illustrates an example system 100 that may allow capture of a video feed and camera pose information, and transmission of the same to a remote device, for interaction and placement of AR objects. System 100 may include a device 102, which may be in communication with a remote device 110. In the depicted embodiment of FIG. 1, device 102 is a smartphone, which may be implemented as a computer device 500, to be discussed in greater detail in FIG. 5. Other embodiments may implement device 102 as a variety of different possible devices, such as a computer (desktop or laptop), tablet, two-in-one, hybrid, smart glasses, or any other computing device that can accept a camera and provide necessary positional information, as will be discussed in greater detail herein. Device 102 further may include a camera 104 and may include one or more spatial position sensors 106 (depicted by a series of axes), to provide information about the spatial position of camera 104. In embodiments such as where device 102 is a smartphone, tablet, or laptop, camera 104 and spatial position sensors 106 may be contained within the body of device 102. In other embodiments, one or more of camera 104 and/or spatial position sensors 106 may be external to device 102, forming a system. For example, camera 104 and spatial position sensors 106 may be housed in an external camera unit that is connected to device 102, which may be a laptop, desktop, or similar type of computer device 500.

Camera 104 is used to capture the surrounding environment of device 102, and by extension, the user. The environment may include one or more three-dimensional objects 108. Camera 104 may be any camera that can provide a suitable video stream for the intended purpose of device 102. Where device 102 is implemented as a smartphone or tablet, camera 104 may be a built-in camera. In other embodiments, such as where device 102 is a laptop, camera 104 may be built in or a separate, external unit. A suitable video stream may be a digital video stream, and may be compressed in embodiments with some form of video compression, such as AVC-HD, H.264, MPEG-4, or another suitable compression scheme. Camera 104 may be configured to output standard or high-definition video, 4K video, or another resolution of video suitable for the intended purpose of camera 104 and device 102. The video stream may further include audio captured by one or more microphones (not pictured) in communication with the device. The video stream and any associated audio may comprise a video feed that is suitable for transmission, as will be discussed in greater detail herein.

Spatial position sensor(s) 106 may be configured to provide positional information about camera 104 that at least partially comprises camera pose information, such as camera 104's pan and tilt. Other measured positional vectors may include camera movements, such as the camera rising or falling, or moving laterally. Spatial position sensors 106 may be implemented with one or more micro and/or MEMS sensors, such as gyroscopes to measure angular movements, accelerometers to measure linear movements such as rises, falls, and lateral movements, and/or other suitable sensors such as a magnetic flux sensor to provide compass heading. In other embodiments, spatial position sensors 106 may be implemented using any suitable technology capable of measuring spatial movements of camera, including but not limited to depth sensors (not depicted).

In some embodiments, either the camera 104 or the spatial position sensor(s) 106 may be capable of making direct depth measurements. For example, either may include depth-sensing and/or range finding technology, such as LiDAR, stereoscopic camera, IR sensors, ultrasonic sensors, or any other suitable technology. In other embodiments, device 102 may be equipped with such depth-sensing or range finding sensors separately or additionally from camera 104 and spatial position sensor(s) 106.

Device 102 may be in communication with one or more remote devices 110, such as via a communications link 112. Remote device 110 may be any suitable computing device, such as computer device 500, which can be configured to receive and present a video feed from device 102 to a user of remote device 110. Remote device 110 may be the same type of device as device 102, or a different type of device that can communicate with device 102. Remote device 110 further may be capable of allowing a user to insert, remove, and/or manipulate one or more AR objects into the video feed, and further may allow the user to communicate with a user of device 102.

Communications links 112a and 112b between device 102, server 114, and remote device 110 may be implemented using any suitable communications technology or technologies, such as one or more wireless protocols like WiFi, Cellular (e.g., 3G, 4G/LTE, 5G, or another suitable technology), Bluetooth, NFC, one or more hardwired protocols like Ethernet, MoCA, Powerline communications, or any suitable combination of wireless and wired protocols. Communications links 112a and 112b may at least partially comprise the Internet. Communications links 112a and 112b may pass through one or more central or intermediate systems, which may include one or more servers, data centers, or cloud service providers, such as server 114. One or more of the central or intermediate systems, such as server 114, may handle at least part of the processing of data from the video feed and/or LiDAR from device 102, such as generating a 3D mesh and/or 3D model, digital twin, and/or may provide other relevant functionality. In embodiments, server 114 may execute some or all of methods 200, 300 and/or 400, described further below. In other embodiments, methods 200, 300 and/or 400 may be executed in part by any or all of device 102, server 114, and/or remote device 110.

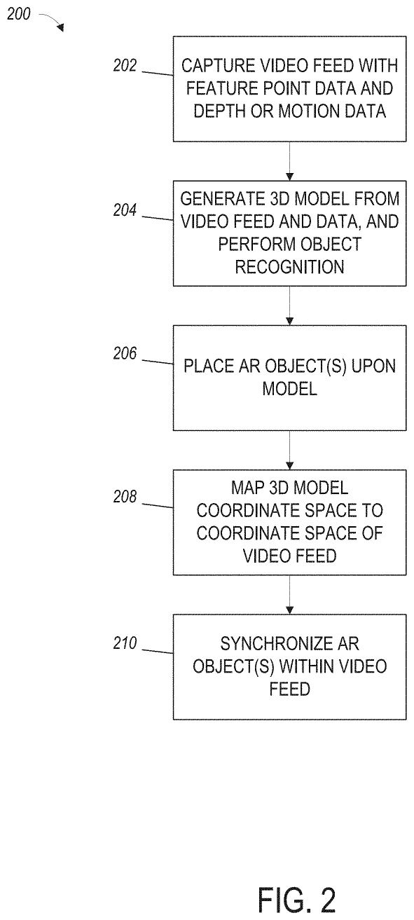

FIG. 2 depicts an example method 200 for generation of a 3D model and placement, where the AR object is reflected into a video stream from an end user device, such as device 102. Various embodiments may implement some or all of the operations of method 200, and the operations of method 200 may be performed in whole or in part, and may be performed out of order in some embodiments. Some embodiments may add additional operations. In some embodiments, method 200 may be executed by device 102 and the result transmitted to remote device 110. In another embodiment, the video feed from device 102 may be transmitted to remote device 110 and remote device 110 may perform method 200.

In operation 202, a video feed may be captured, with or without an associated depth and/or motion data as described above with respect to FIG. 1. The captured video may come from a variety of sources. In some examples, a camera 104 is used to capture the video, and one or more spatial position sensors 106 may be used to capture motion data, including camera pose information. In other examples, a different device or devices may be used to capture the video feed, depth data and/or motion data. The video feed and associated depth/motion data may be captured at a previous time, and stored into an appropriate file format that captures the video along with the depth/motion data. In some embodiments, the motion data may include depth and/or point cloud information, which itself may have been computed from the motion data and video feed, such as will be discussed below with respect to methods 300 and 400. In other embodiments, and as mentioned above with respect to FIG. 1, either camera 104 or spatial position sensors 106, or a dedicated depth sensor, may directly capture depth data. The result from operation 202, in some embodiments, is a video feed with associated point cloud data, or raw motion data from which the point cloud data is computed.

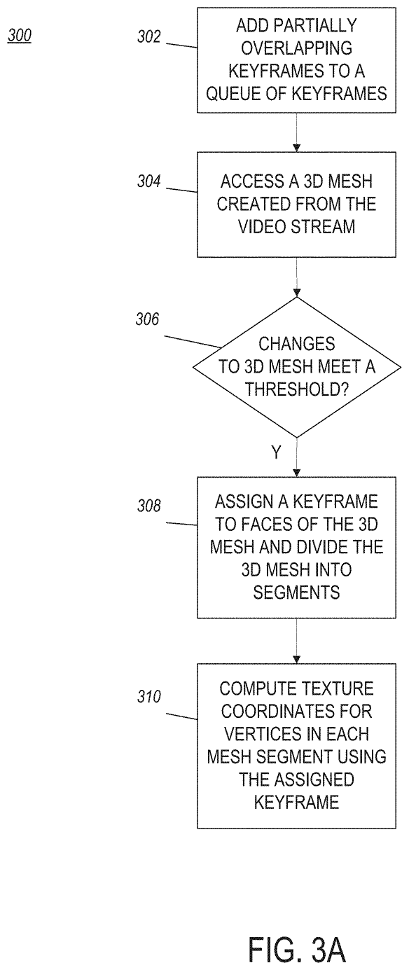

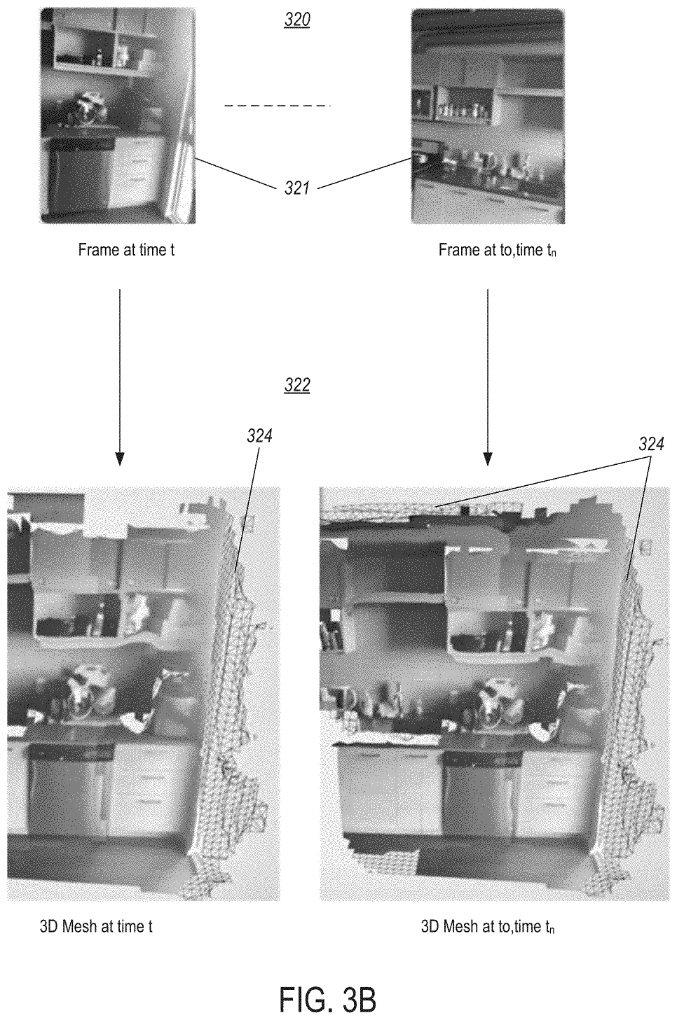

In operation 204, the video feed, motion data, and optionally depth data, are used to construct a 3D model/digital twin with which a remote user can interact. The 3D model/digital twin may be constructed by first generating a 3D mesh from camera pose information and point cloud or other depth information. Image information from the video feed may then be integrated with the 3D mesh to form the 3D model/digital twin, such via a texture mapping process. In some embodiments, techniques known in the art may be used to generate the 3D mesh and/or the 3D model/digital twin. Method 300, described below with respect to FIG. 3A, is one possible process that can be implemented to perform a real-time texture mapping process on the 3D mesh using images from the video feed.

Furthermore, in embodiments, object recognition may be performed on the 3D model/digital twin to detect various features, such as appliances, furniture, topographical features such as surfaces and/or shapes, or other various relevant features. In some embodiments, object recognition may be performed on the initial video stream prior to model generation, with the recognized features identified in the resulting 3D model/digital twin. In other embodiments, object recognition may be performed directly on the 3D model/digital twin. Generation of the 3D model/digital twin may be by an iterative or continuous process, rather than a single static generation, with the model being expanded as the device providing the live video feed moves about its environment and captures new aspects. The 3D model/digital twin may also be updated in real time to accommodate environmental changes, such as objects being moved, new objects/features being exposed due to persons moving about, in, or out of the video frame, etc.

Following generation of the 3D model/digital twin, in embodiments, it is made available to users' remote devices in real-time, such as a user of remote device 110. In operation 206, a user may place, tag, or otherwise associate one or more AR objects within the 3D model/digital twin. The AR objects may be tagged or associated with one or more objects within the 3D model/digital twin, such as objects recognized via object recognition performed as part of operation 204. The position of such AR objects may be expressed with respect to the coordinates of some part of the tagged or associated object. The coordinates of the AR objects within the 3D model/digital twin coordinate system may be determined by resolving the reference to the tagged or associated object. Other AR objects may be tagged to a specified location within the 3D model/digital twin, with the location of such AR objects expressed in terms of the 3D model/digital twin's coordinate system rather than relative to the coordinates of an object.

The choice of how to express the location of a given AR object within the 3D model/digital twin may depend upon the nature of the AR object. For example, where an AR object is intended to relate to a recognized object, e.g., pointing out a feature of some recognized object, it may be preferable to locate the AR object relative to the recognized object, or some anchor point or feature on the recognized object. In doing so, it may be possible to persist the placement of the AR object relative to the recognized object even if the recognized object is subsequently moved in the video feed, and the corresponding 3D model/digital twin is updated to reflect the new position of the moved object. Likewise, it may be preferable to tie an AR object to an absolute location within the 3D model/digital twin when the AR object is intended to represent a particular spatial position within the environment of the video feed, e.g. the AR object is a piece of furniture or otherwise indicates a location in the area surrounding the device providing the video feed, such that tagging to a recognized object is unnecessary or undesirable.

As will be understood, the AR objects may be two-dimensional or three-dimensional objects, such as may be provided by an image library or 3D object library. Placement of the AR objects can include determining AR object orientation within the model, e.g., its location within a 3D coordinate space as well as rotational orientation relative to three axes, pitch, yaw, and roll, so that the AR object is expressed in at least six degrees of freedom.

In operation 208, the coordinate space of the 3D model/digital twin is mapped to the coordinate space of the video feed. The 3D model/digital twin may be represented in a 3D coordinate space with reference to an origin point, which may be arbitrarily selected. In some embodiments, the origin may be relocated or shifted as the 3D model/digital twin evolves, such as where the 3D model/digital twin is continuously generated and expanded as the video feed progresses. The point of view of the camera may change, such as due to the user of the device providing the video feed moving the device about. While depicted as a single step, it should be understood that in some embodiments, the coordinate space between the 3D model/digital twin and video feed may be continuously reconciled.

One possible way in some embodiments of mapping the coordinate space of the 3D model/digital twin with the video feed includes correlation of anchor points. As mentioned above, one or more anchor points may be identified from the video feed. These anchor points serve as locations within the environment around the capturing device that can be repeatedly and consistently identified when the point moves out of and back into frame. These anchor points can be identified, tagged, or otherwise associated with corresponding objects within the 3D model/digital twin, such as by specifically identifying the anchor points in point cloud data, which is then used in the process of 3D model/digital twin generation. The identified points in the 3D model/digital twin that correspond to the anchor points in the video feed thus provide fixed reference points common between the coordinate spaces of the 3D model/digital twin and video feed. By comparing the expression of the location of a given anchor point within the 3D model/digital twin to its corresponding location expression within the video feed, the various mathematical factors needed to translate between the two coordinate systems can be determined. With this information, the position of the object placed within the 3D model/digital twin can be translated to positional information for placement within the video feed coordinate space.

The mathematical factors may include scale amounts, for example to correlate the relative sizes and distances of objects within the video feed with objects generated in the 3D model/digital twin, as well as placed AR objects. These scale amounts can also be useful for making measurements within the 3D model/digital twin, e.g. distances, sizes, volumes, etc., and having these measurements accurately reflect the environment surrounding the device providing the video feed.

In operation 210, the AR object(s) remotely placed in operation 206 are synchronized back to the video feed, using the mapping between the 3D model/digital twin coordinate space and video feed coordinate space established in operation 208. As a result, a user interacting with the 3D model/digital twin can place one or more AR objects within the model at location(s) that are currently out of frame from the video feed, and have the one or more AR objects appear in the video feed at their correct placed locations once the device providing the video feed moves to place the locations of the AR objects into frame. The appearance of the AR objects may also be generated with respect to the AR object's orientation, e.g. pitch, roll, and yaw, as discussed above with respect to operation 206. Thus, in operation 210 the AR objects are rendered for the video feed with respect to the point of view of the device providing the video feed, rather than the point of view of the user of the 3D model/digital twin who is placing the AR objects.

Depending upon the capabilities of an implementing system or device, method 200 may be performed progressively while the video is being captured, or may be performed on a completely captured video and associated AR data. As suggested above, in some embodiments the 3D model/digital twin may be computed on the fly, in real time, from the video feed, and/or depth or motion data as described above in operation 202, from a user device. As it is being generated, the model/digital twin may be updated in real-time if the environment captured in the video feed changes, such as by moving one or more objects.

It should be appreciated by a person skilled in the art that some or all of method 200 may be performed by one or more components of system 100. For example, device 102 may provide the video feed and at least part of the depth data, motion data and/or point cloud data. The user of the remote device 110 may interact with the 3D model/digital twin, including placement of one or more 3D objects that are reflected back into the video feed or scene. In some embodiments, one of the remote device 110, server 114, and/or device 102 may be responsible for generation of the 3D model/digital twin, and/or another remote system, such as a central server, cloud server, or another computing device that may be part of the communications link 112.

Furthermore, some of the operations of method 200 may be performed in real-time during video feed capture. As the video feed is stored, the video feed may be processed and the 3D model/digital twin generated on the fly from the video feed with real-time texture mapping. Optionally, AR objects may be subsequently placed and then made visible in subsequent playback of the video feed. In other embodiments, some of the operations of method 200 may be performed off-line, post-capture of the video feed. For example, the video feed may be stored, either on device 102, server 114, remote device 110, or another remote system. The 3D model/digital twin may be subsequently generated following video feed capture, and/or AR objects placed within the 3D model/digital twin following video feed completion and capture. The video feed in turn may be associated with a stored version of the 3D model/digital twin. In still other embodiments, the 3D model/digital twin may additionally or alternatively be tagged or associated with a geolocation corresponding to the capture of the video feed, such that a subsequent device capturing a new video feed in the associated geolocation can incorporate one or more of the AR objects placed within the associated 3D model/digital twin.

Further, it should be understood that, while the foregoing embodiments are described with respect to a device 102 that may provide a video feed, system 100 and/or method 200 may be adapted to work with other technologies, e.g. waveguides and/or other see-through technologies such as smart glasses or heads-up displays, which may project AR objects onto a view of the real world, rather than a video screen or electronic viewfinder. In such embodiments, for example, sensors including video, depth, and/or motion sensors, may be used to construct the 3D model or digital twin, with which the remote user may interact and place AR objects. The remote user may or may not see a video feed that corresponds to the user's view through device 102; in some embodiments, the remote user may simply see the 3D model/digital twin, which may be updated/expanded in real time as the user of device 102 moves above. AR objects placed in the 3D model/digital twin, rather than being overlaid on a video feed, would be projected onto the user's view of the real world through device 102 in synchronization with the 3D model/digital twin.

Finally, one or more operations of method 200, such as operation 210, may be performed in reverse. For example, a user may place an object into the video feed, and have it reflect back into the corresponding 3D model or digital twin. Once the coordinate space of the 3D model/digital twin and video feed are mapped in operation 208, objects may be placed either in the model/twin or in the video feed, and be synchronized together.

Referring now to FIG. 3A, an example process 300 performed by a texture mapping component for real-time texture mapping of a 3D model according to some embodiments is described. As used herein, texture mapping of a 3D model in real-time refers to performing texture mapping contemporaneously as the 3D model/digital twin is continuously generated and expanded as the video feed progresses. Various embodiments may implement some or all of the operations of method 300, and the operations of method 300 may be performed in whole or in part by computing device 102 or remote device 110, and may be performed out of order in some embodiments. Some embodiments may add additional operations. In some embodiments, method 300 does not need to be executed in whole or in part by server 114.

In operation 302, a video stream or other sequence of frames of a scene or environment captured by a capturing device (e.g., device 102) is received and keyframes that partially overlap in the sequence of frames are detected and added to a queue of keyframes.

FIG. 3B illustrates an example video stream 320. In the example video stream 320, the camera is panning from right to left during image capture. The video stream 320 comprises a sequence or timeline of many images or frame 321. In some embodiments, a keyframe is frame 321 in the timeline that defines starting and ending points of a transition or indicates a beginning or end of a change made to a parameter of the video. Stated differently, a sequence of keyframes may define what movement a viewer will see, and the position of the keyframes on the video defines the timing of the movement.

In some embodiments, at any time t, keyframes are added to the queue of keyframes if a pair of neighboring keyframes partially overlap greater than 5%, e.g., from 5-30%, to cover as much of the physical scene depicted as possible. In one embodiment, an overlap between a given pair of neighboring keyframes can be identified by determining whether each of the keyframes shares at least a predetermined number of points in the sparse depth map. In one example embodiment, at any given time t, the queue may be configured store 50-300 keyframes and may be implemented as a first-in-last-out (FIFO) queue. In some embodiments, a plurality of keyframes is automatically extracted from the sequence of frames as described in U.S. Patent Application No. 63/318,684 (P032Z).

In some embodiments and depending upon the capabilities of the capturing device, camera pose information may also be captured and received with the frames 321. The camera pose information may include rotational information such as camera pan, tilt, and yaw, translational information such as breadth, width, and depth movements, as well as camera intrinsic information such as focal length, image sensor format (e.g. sensor resolution, possibly expressed in x by y dimensions), focus point/distance, depth of field, aperture size (related to depth of field), lens distortion parameters (if known), etc. Depending upon the implementation, not all of this information may be available.

Referring again to FIG. 3A, in operation 304, the process accesses a 3D mesh that was created from the sequence of frames. In some embodiments, the 3D mesh may be created from another process and accessed from memory by the current process. For example, a 3D mesh of triangles may have been generated from depth maps (or a densified point cloud), using a suitable algorithm such as Volumetric TSDF (Truncated Signed Distance Function) Fusion, Poisson Reconstruction or Delaunay Reconstruction.

In operation 306, it is determined when changes to a property of the 3D mesh meet a predetermined threshold. Example properties of the 3D mesh may include one or more of a number of faces, triangles, vertices, or an area of the 3D mesh. For example, it may be determined that the 3D mesh is changed or updated beyond a threshold based on a number of new triangles or faces created.

The bottom portion of FIG. 3B also shows an example 3D mesh 322 created from the frames of the video stream 320 over time. As shown, the 3D mesh 322 comprises a number of faces or triangles defined by vertices. As the camera pans, the 3D mesh 322 is also expanded, creating more faces or triangles 324 over time (e.g., time t to time tn). Operation 306 in FIG. 3A tracks the number of changes or updates to one or more of the mesh properties over a predetermined time or since a previous update. The actual thresholds to compare the changes made to the 3D mesh properties may depend on the type of video streaming, and the size of the mesh. This check of the 3D mesh properties is to make sure the 3D mesh changes sufficiently to warrant an update to the texture process, which can be time consuming or process intensive. It should be noted that FIG. 3B shows most of the faces of the 3D mesh 322 with texturing for illustration, but the texturing process occurs later in operation 310.

Referring again to FIG. 3A, in operation 308, once the changes to a 3D mesh property meets the threshold, faces in the 3D mesh are assigned one of the keyframes from the queue of keyframes, and the 3D mesh is divided into mesh segments based on the assigned keyframes. This step determines for each face in the 3D mesh, which of the keyframes is most suitable to be used for texture mapping. All the faces associated with the same keyframe comprise a particular mesh segment of the 3D mesh and each of the mesh segments is represented by one of the keyframes. For example, if 100 triangles/faces are seen in a single keyframe, then those faces are added to a mesh segment for that keyframe.

Finally, in operation 310, for each of the mesh segments, the process uses the keyframe assigned to the respective mesh segment to compute texture coordinates for vertices in the mesh segment, and assigns the image in the keyframe as a texture for the respective mesh segment. The 3D mesh is then textured by reprojecting the various images from the video or sequence of keyframes onto the 3D mesh. In one embodiment, method 300 is performed in real-time on an on-going video stream. Thus, where performed in real-time, operations 302-310 may be performed in a loop and/or simultaneously, as the 3D model is progressively constructed, densified, and textured, with the model being refined as the capturing device pans back over previously captured areas of the environment, enabling refining of details. In other embodiments, the method can be performed in a single pass on a recorded video or may be performed iteratively.

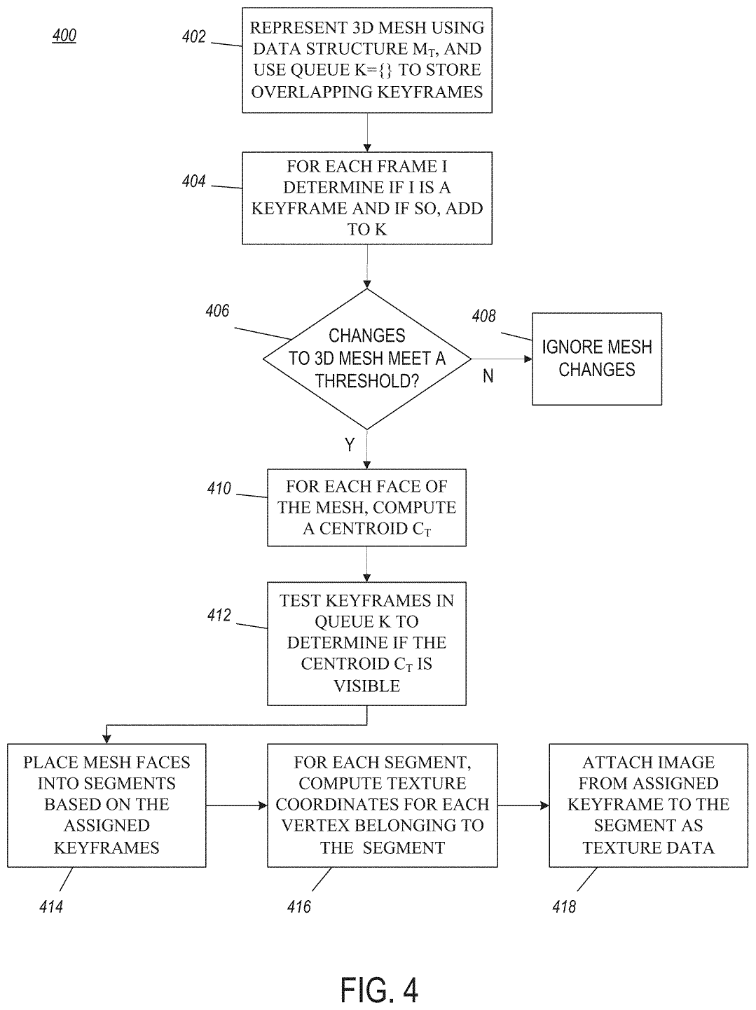

FIG. 4 illustrates an example process 400 for real-time texture mapping of a 3D model according to some embodiments is described in further detail. Operations 402 and 404 illustrate details of operation 302 (maintaining a keyframe queue). In operation 402, the 3D mesh at time t is represented using data structure Mt, and a queue K={ } is used to store the set of overlapping keyframes from the incoming video stream. Mt comprises a set of vertices Vt and a set of faces/triangles Ft. K is initially empty at the beginning of the video session, and is updated with automatically detected keyframes as the session continues.

In operation 404, for every new frame I from the video stream, the process determines if I is a keyframe, as described above, and if so, I is added to K. In one embodiment, frame I may comprise an image and camera information (camera transform and camera intrinsics). Once the number of keyframes in K exceeds a predefined limit (e.g., 50-150), one or more of the oldest keyframes in K are deleted.

Operations 406 and 408 illustrate details of operation 306 (checking changes to the mesh). In operation 406, for every new change to Mt, the process determines whether a difference in a property of the mesh Mt has met or exceeded a predefined limit or threshold. For example, this may be done by receiving an update notification, and in response, determining a difference between the number of vertices in Mt and M(t−1) to determine if the threshold is met. In operation 408, if the difference does not meet the predefined limit, the mesh change/update may be ignored until the next update notification, otherwise, the process proceeds with mesh segmentation and the texture mapping of Mt.

Operations 410-414 illustrate the details of operation 308 (mesh segmentation). In operation 410, for each face/triangle Ft of the mesh, the process computes a centroid Ct from vertices defining the face. In operation 412, the keyframes in the queue K are tested (from the most recent to the oldest) to determine if the centroid Ct of Ft is visible within the keyframe. In one embodiment, a face is visible if a dot product of a face normal and the camera direction (determined by the camera data) is less than 0 (i.e., the angles are less than 90 degrees). The search can be stopped as soon as a keyframe k is found where Ct is visible, and the found keyframe is assigned to that face. Thus, the process assigns a keyframe k to every face. In operation 414, the mesh faces are placed into segments based on the assigned keyframes, where one segment is created for each keyframe.

Operations 416-418 illustrate the details of operation 310 (texture coordinates computation). In operation 416, for each mesh segment, the process computes texture coordinates for each vertex belonging to the mesh segment. Let Tk be the camera to world transform and Ek be the camera intrinsics of the keyframe k assigned to the mesh segment. A texture coordinate for a vertex vt is computed by projecting Vt to the image space using:

TCt=Ek*inverse(Tk)*vt,

where inverse(Tk)*vt translates from world coordinates to camera coordinates, and Ek translates camera coordinates to image space to calculate where in the image the vertex is located. TCt is added to a list or table of stored texture coordinates. In operation 418, once a set of texture coordinates is computed for each vertex, the process attaches the image from the assigned keyframe to that mesh segment as texture data. This is sufficient for any 3D rendering pipeline executing on the computing device to display the textured mesh segment. This process is repeated for every mesh segment.

It should be appreciated that, as with method 300, method 400 can be performed in a single pass on a recorded video, or may be performed iteratively in real time on an on-going video stream. When performed in real time, all operations 402, 404, 406, and 408 may be performed in a loop and/or simultaneously, as the estimated metric scale of the video stream is refined as the capturing device pans back over previously captured areas of the environment and enables refining of details. Furthermore, method 400 may be used in conjunction with method 300 to provide metric scale estimation where insufficient camera pose data is supplied.

Finally, method 300 and, where needed, method 400 may be performed as part of operation 204 of method 200 (FIG. 2).

FIG. 5 illustrates an example computer device 500 that may be employed by the apparatuses and/or methods described herein, in accordance with various embodiments. As shown, computer device 500 may include a number of components, such as one or more processor(s) 504 (one shown) and at least one communication chip 506. In various embodiments, the one or more processor(s) 504 each may include one or more processor cores. In various embodiments, the one or more processor(s) 504 may include hardware accelerators to complement the one or more processor cores. In various embodiments, the at least one communication chip 506 may be physically and electrically coupled to the one or more processor(s) 504. In further implementations, the communication chip 506 may be part of the one or more processor(s) 504. In various embodiments, computer device 500 may include printed circuit board (PCB) 502. For these embodiments, the one or more processor(s) 504 and communication chip 506 may be disposed thereon. In alternate embodiments, the various components may be coupled without the employment of PCB 502.

Depending on its applications, computer device 500 may include other components that may be physically and electrically coupled to the PCB 502. These other components may include, but are not limited to, memory controller 526, volatile memory (e.g., dynamic random access memory (DRAM) 520), non-volatile memory such as read only memory (ROM) 524, flash memory 522, storage device 554 (e.g., a hard-disk drive (HDD)), an I/O controller 541, a digital signal processor (not shown), a crypto processor (not shown), a graphics processor 530, one or more antennae 528, a display, a touch screen display 532, a touch screen controller 546, a battery 536, an audio codec (not shown), a video codec (not shown), a global positioning system (GPS) device 540, a compass 542, an accelerometer (not shown), a gyroscope (not shown), a speaker 550, a camera 552, and a mass storage device (such as hard disk drive, a solid state drive, compact disk (CD), digital versatile disk (DVD)) (not shown), and so forth.

In some embodiments, the one or more processor(s) 504, flash memory 522, and/or storage device 554 may include associated firmware (not shown) storing programming instructions configured to enable computer device 500, in response to execution of the programming instructions by one or more processor(s) 504, to practice all or selected aspects of the system 100 and/or method 200, described herein. In various embodiments, these aspects may additionally or alternatively be implemented using hardware separate from the one or more processor(s) 504, flash memory 522, or storage device 554.

The communication chips 506 may enable wired and/or wireless communications for the transfer of data to and from the computer device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The computer device 500 may include a plurality of communication chips 506. For instance, a first communication chip 506 may be dedicated to shorter range wireless communications such as Wi-Fi and Bluetooth, and a second communication chip 506 may be dedicated to longer range wireless communications such as GPS, EDGE, GPRS, CDMA, WiMAX, LTE, Ev-DO, and others.

In various implementations, the computer device 500 may be a laptop, a netbook, a notebook, an ultrabook, a smartphone, a computer tablet, a personal digital assistant (PDA), a desktop computer, smart glasses, or a server. In further implementations, the computer device 500 may be any other electronic device that processes data.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

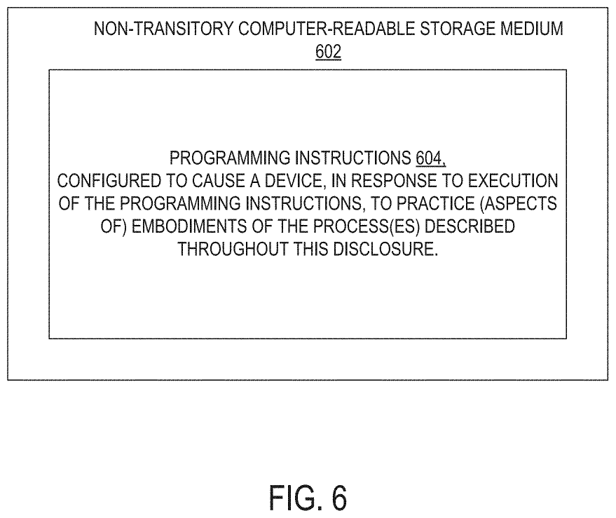

FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable a device, e.g., computer device 500, in response to execution of the programming instructions, to implement (aspects of) system 100 or method 200. In alternate embodiments, programming instructions 604 may be disposed on multiple computer-readable non-transitory storage media 602 instead. In still other embodiments, programming instructions 604 may be disposed on computer-readable transitory storage media 602, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Although certain embodiments have been illustrated and described herein, it will be appreciated by those of ordinary skill in the art that a wide variety of alternate and/or equivalent P032 embodiments or implementations calculated to achieve the same purposes may be substituted for the embodiments shown and described without departing from the scope. Those with skill in the art will readily appreciate that embodiments may be implemented in a very wide variety of ways.

This application is intended to cover any adaptations or variations of the embodiments discussed herein. Therefore, it is manifestly intended that embodiments be limited only by the claims and the equivalents thereof.

1. A method comprising:
receiving, at a computing device, a sequence of frames of a scene captured by a capturing device, and adding keyframes that partially overlap in the sequence of frames to a queue of keyframes;
accessing, by the computing device, a 3D mesh created from the sequence of frames;
determining, by the computing device, when changes to a property of the 3D mesh meet a predetermined threshold;
assigning to each face in the 3D mesh, by the computing device, one of the keyframes from the queue of keyframes, and dividing the 3D mesh into mesh segments based on the assigned keyframes; and
using, by the computing device, the keyframe assigned to each of the mesh segments to compute texture coordinates for vertices in the respective mesh segment, and assigning an image in the keyframe as a texture for the respective mesh segment.

2. The method of claim 1, further comprising: adding, by the computing device, at any time t, the pair of neighboring keyframes to the queue of keyframes when the pair of neighboring keyframes partially overlap greater than 5%.

3. The method of claim 1, wherein adding keyframes that partially overlap in the sequence of frames to a queue of keyframes further comprises: determining, by the computing device, whether each of a pair of neighboring keyframes shares at least a predetermined number of points in a sparse depth map.

4. The method of claim 1, further comprising: implementing the queue of keyframes as a first-in-last-out (FIFO) queue.

5. The method of claim 1, wherein determining when changes to a property of the 3D mesh meet a predetermined threshold further comprises: including as the property of the 3D mesh one or more of a number of faces, triangles, vertices, or an area of the 3D mesh.

6. The method of claim 5, further comprising:
representing the 3D mesh at time t using data structure Mₜ, Mₜ comprising a set of vertices and a set of faces or triangles Fₜ;
responsive to receiving an update notification, determining a difference between a number of vertices in Mₜ and M₍ₜ₋₁₎; and
if the difference is less than the predetermined threshold, ignoring the change to the 3D mesh until a next update notification.

7. The method of claim 1, wherein assigning to each face in the 3D mesh one of the keyframes from the queue of keyframes, and dividing the 3D mesh into mesh segments based on the assigned keyframes further comprises:
representing the 3D mesh at time t using data structure Mₜ, Mₜ comprising a set of vertices and a set of faces Fₜ;
for each of the faces Fₜ, searching and testing the keyframes in the queue of keyframes from the most recent to oldest to determine if a centroid Cₜ of Fₜ is visible within the respective keyframe; and
stopping the search when a keyframe k is found where Cₜ is visible, and assigning the keyframe k to the face Fₜ.

8. The method of claim 7, wherein determining if the centroid Cₜ of Fₜ is visible within the respective keyframe further comprises: determining the face Fₜ is visible when a dot product of a face normal and a camera direction is less than 0.

9. The method of claim 1, further comprising:
passing, by the computing device, each frame of the sequence of frames through a depth estimation network to obtain an estimated depth map;
rendering, by the computing device from the sparse depth map, a depth map representing a camera view; and
fitting, by the computing device, the camera view depth map to the estimated depth map to obtain a depth map with an estimated metric scale.

10. The method of claim 1, wherein computing texture coordinates for the vertices further comprises: representing a camera to world transform as Tk and representing intrinsics of the camera of the keyframe k assigned to the mesh segment as Ek; computing a texture coordinate for a vertex vt by projecting Vt to an image space using:
TCt=Ek*inverse(Tk)*vt.

11. A non-transitory computer readable medium (CRM) comprising instructions that, when executed by an apparatus, cause the apparatus to:
receive, at a computing device, a sequence of frames of a scene captured by a capturing device, and adding keyframes that partially overlap in the sequence of frames to a queue of keyframes;
access, by the computing device, a 3D mesh created from the sequence of frames;
determining, by the computing device, when changes to a property of the 3D mesh meet a predetermined threshold;
assign to each face in the 3D mesh, by the computing device, one of the keyframes from the queue of keyframes, and dividing the 3D mesh into mesh segments based on the assigned keyframes; and
use, by the computing device, the keyframe assigned to each of the mesh segments to compute texture coordinates for vertices in the respective mesh segment, and assigning an image in the keyframe as a texture for the respective mesh segment.

12. The CRM of claim 11, further comprising: adding, by the computing device, at any time t, the pair of neighboring keyframes to the queue of keyframes when the pair of neighboring keyframes partially overlap greater than 5%.

13. The CRM of claim 11, wherein adding keyframes that partially overlap in the sequence of frames to a queue of keyframes further comprises: determining, by the computing device, whether each of a pair of neighboring keyframes shares at least a predetermined number of points in a sparse depth map.

14. The CRM of claim 13, further comprising: implementing the queue of keyframes as a first-in-last-out (FIFO) queue.

15. The CRM of claim 11, wherein determining when changes to a property of the 3D mesh meet a predetermined threshold further comprises: including as the property of the 3D mesh one or more of a number of faces, triangles, vertices, or an area of the 3D mesh.

16. The CRM of claim 15, further comprising:
representing the 3D mesh at time t using data structure Mₜ, Mₜ comprising a set of vertices and a set of faces or triangles Fₜ;
responsive to receiving an update notification, determining a difference between a number of vertices in Mₜ and M₍ₜ₋₁₎; and
if the difference is less than the predetermined threshold, ignoring the change to the 3D mesh until a next update notification.

17. The CRM of claim 11, wherein assigning to each face in the 3D mesh one of the keyframes from the queue of keyframes, and dividing the 3D mesh into mesh segments based on the assigned keyframes further comprises:
representing the 3D mesh at time t using data structure Mₜ, Mₜ comprising a set of vertices and a set of faces Fₜ;
for each of the faces Fₜ, searching and testing the keyframes in the queue of keyframes from the most recent to oldest to determine if a centroid Cₜ of Fₜ is visible within the respective keyframe; and
stopping the search when a keyframe k is found where Cₜ is visible, and assigning the keyframe k to the face Fₜ.

18. The CRM of claim 17, wherein determining if the centroid Cₜ of Fₜ is visible within the respective keyframe further comprises: determining the face Fₜ is visible when a dot product of a face normal and a camera direction is less than 0.

19. The CRM of claim 11, further comprising:
passing, by the computing device, each frame of the sequence of frames through a depth estimation network to obtain an estimated depth map;
rendering, by the computing device from the sparse depth map, a depth map representing a camera view; and
fitting, by the computing device, the camera view depth map to the estimated depth map to obtain a depth map with an estimated metric scale.

20. The CRM of claim 11, wherein computing texture coordinates for the vertices further comprises: representing a camera to world transform as Tk and representing intrinsics of the camera of the keyframe k assigned to the mesh segment as Ek; computing a texture coordinate for a vertex vt by projecting Vt to an image space using:
TCt=Ek*inverse(Tk)*vt.
